(19) United States
(12) Patent Application Publication
(10) Pub. No.: US 2005/0003810 A1
(43) Pub. Date: Jan. 6, 2005

(54) Method and system for optimizing software program start-up time

(75) Inventors: Singyun B. Chu, Mountain View, CA (US); Nikolay Igotti, St. Petersberg (RU)

Correspondence Address: MARTINE & PENILLA, LLP, 710 LAKEWAY DRIVE, SUITE 170, SUNNYVALE, CA, 94085, US

(73) Assignee: Sun Microsystems, Inc., Santa Clara, CA (US)

(21) Appl. No.: 10/447,559

(22) Filed: May 28, 2003

(51) Int. Cl. H04M 3/00

(52) U.S. Cl. 455/418; 455/419; 455/420

(57) ABSTRACT

A method for installing an application on a mobile device is provided. The method includes obtaining the application over a network and storing the application on the mobile device. The method further includes processing the application on the mobile device to generate a processed application. Also include in the method is storing the processed application on the mobile device and requesting access to the application. The method also includes mapping the request to access the application to the processed application and launching the processed application on the mobile device.

### BACKGROUND OF THE INVENTION

1. Field of the Invention

This invention relates generally to mobile devices, and more particularly to systems and methods for optimizing start-up time of optional applications being installed on mobile devices.

2. Description of the Related Art

Today, embedded mobile devices are being increasingly used by consumers all around the world which has lead to an ever-increasing demand for additional services. For instance, embedded mobile device users were initially limited to using closed system mobile devices. That is, the users could only implement applications pre-installed on the embedded mobile device.

As consumer demands have increased and new technologies have developed, in addition to the pre-installed applications, consumers are able to access and use applications that are being executed on the severs connected to the mobile devices. The trade off, however, is that mobile devices must be connected to a server continuously while a consumer is running the application on the mobile device. Of course, one of ordinary skill in the art appreciates that maintaining continuous connection with the server for an extended period of time can be costly and will restrict free movement of the users.

As an alternative, applications can be downloaded from a server application bank into the embedded mobile device, allowing the downloaded application to run on the mobile device. In such situations, the embedded mobile device is only in communication with the server while the application is being downloaded to the device. In this manner, the connection time is shortened, thus reducing the connection costs and increasing user mobility.

While the connection costs are reduced, per use, the downloading and execution of the application must be performed every single time the user chooses to utilize the application. Furthermore, execution of applications from servers involves additional complex issues. Primarily, applications downloaded from the server cannot be launched in the same way as a pre-installed application. At times, it may take an application between 10 seconds and 2 minutes or longer to be loaded. As can be appreciated, such delay in loading applications is aggravating to consumers, which can leave consumers less than satisfied.

Furthermore, different embedded mobile devices implement diverse platforms. Thus, applications stored to a server application bank, generally, do not have a generic format making them platform specific. For such applications to be downloaded and executed on embedded mobile devices, the devices must first provide the server information regarding the type of the device platform, version, etc. Only then, the server can send the device the application in the format matching that of the embedded mobile device platform. Once the application is downloaded, the device then has to process the application so that the application can be executed, which depending on the device and application can take more time than the average user is willing to spend.

In view of the foregoing, a need therefore exists in the art for a method and system capable of optimizing start-up time of applications that can be optionally downloaded and installed on mobile devices.

### SUMMARY OF THE INVENTION

Broadly speaking, the present invention fills this need by providing a method and a system for optimizing the start-up time of downloadable applications installed on a mobile device. In one embodiment, downloadable applications are downloaded from a server to a device and are pre-processed in the device. It should be appreciated that the present invention can be implemented in numerous ways, including as a process, an apparatus, a system, a device, or a method. Several inventive embodiments of the present invention are described below.

In one embodiment, a method for installing an application on a mobile device is provided. The method includes obtaining the application over a network following by storing the application on the mobile device. The method further includes processing the application on the mobile device to generate a processed application. Also include in the method is storing the processed application on the mobile device and requesting access to the application. The method also includes mapping the request to access the application to the processed application and launching the processed application on the mobile device.

In another embodiment, a method for accessing an application on a mobile device is provided. The method includes obtaining the application over a network and storing the application on the mobile device. Also included is processing the application on the mobile device to generate a processed application. The method further includes storing the processed application on the mobile device and requesting access to the application after installing the application on the mobile device. The request is mapped to the processed application and the processed application is launched.

In still another embodiment, a method for improving start-up time of a downloadable application on a device is provided. The method includes downloading an entry of the downloadable application to the device and pre-processing the entry on the device. Also included is generating a pre-processed entry and executing the downloadable application on the device using the pre-processed entry.

In yet another embodiment, a method for improving start-up time of a downloadable application on a device is provided. The method includes downloading an entry of the downloadable application to the device and decompressing the entry on the device generating a decompressed entry. Also included in the method is converting the decompressed entry into a native format of the device generating a pre-processed entry. The method also includes generating a cache file configured to include a mapping of the entry to the pre-processed entry. Further included in the method is executing the downloadable application on the device using the pre-processed entry.

In still another embodiment, a method for uninstalling a downloadable application installed on a device is provided. The method includes deleting an entry of the downloadable application previously installed on the device. The method further includes deleting the pre-processed entry corresponding to the entry and deleting a cache file.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified block diagram of an exemplary system depicting the selection of a downloadable application to be installed on an embedded mobile device, in accordance with one embodiment of the present invention.

FIG. 2 shows a simplified block diagram of the system shown in FIG. 1 during installation of a MIDlet, in accordance with one embodiment of the present invention.

FIG. 3 is a simplified block diagram illustrating the contents of an exemplary storage of an exemplary embedded mobile device subsequent to installation of a downloadable MIDlet, in accordance with another embodiment of the invention.

FIG. 4 is a simplified block diagram of an exemplary pre-processing state, in accordance with yet another embodiment of the invention.

FIG. 5 is a block diagram illustrating exemplary actions performed during an installation phase of an exemplary downloadable application in an exemplary mobile device, in accordance with still another embodiment of the invention.

FIG. 6A is a block diagram illustrating exemplary actions performed during a run time phase of a downloadable application in an exemplary device, in accordance with yet another embodiment of the invention.

FIG. 6B is a simplified diagram showing mapping of entries between the original entries to the pre-processed entries, in accordance with still another embodiment of the invention.

FIG. 7 is a flowchart diagram of method operations performed during installation of a downloadable application, in accordance with still another embodiment of the present invention.

FIG. 8A depicts a flowchart diagram of method operations performed during installation of a downloadable application from a server, in accordance with yet another embodiment of the present invention.

FIG. 8B depicts a flowchart diagram of method operations performed during pre-processing of exemplary the JAR and JAD files, in accordance with yet another embodiment of the present invention.

FIG. 9 is a flowchart diagram of method operations performed to uninstall a downloadable application installed on a device, in accordance with yet another embodiment of the present invention.

### DETAILED DESCRIPTION OF THE PREFERRED EMBODIMENTS

Inventions for optimizing the start-up time of downloadable applications installed on a mobile device are provided. Several exemplary embodiments of the invention will now be described in detail with reference to the accompanying drawings.

The embodiments of the present invention provide methods and system for optimizing the start-up time of downloadable applications installed on a mobile device. In one embodiment, during the installation of an application on the device, the application is downloaded from a server application repository to the device in which the application is subsequently pre-processed. In one example, the server is a Java™ 2 Enterprise Edition (J2EE)™ server serving Java applications specially designed for mobile devices. Of course, the server-device communication interface can take on many forms, and can be a product developed by any company, so long as the claimed functions can be executed thereon.

In one example, upon receiving a request from a device, a server provides a list of downloadable entries suitable to be downloaded to the device. “Downloadable applications” or “downloadable MIDlets” are herein defined as applications or MIDlets that can be downloaded, and executed on a device in the same manner as a pre-installed application or MIDlet. Upon selecting a downloadable entry, a Java Application Descriptor (JAD) file of the selected entry is dispatched to the embedded mobile device. In one example, the JAD file includes the text description of the application or MIDlet. If the embedded mobile device can accommodate the requirements of the selected entry, the Java Archive (JAR) file of the selected entry is dispatched to the embedded mobile device. In one embodiment, the JAR file contains the class files of the application or MIDlet as well as all extra auxiliary resources associated with the application or MIDlet.

At this point, the JAD file and the JAR file of the selected entry are pre-processed and mapped to a corresponding mapped entry using a sharable computer code stored to a cache file. In one embodiment, the pre-processing of an entry includes decompressing of the files thereon and translating of the decompressed files into the device hardware native format.

In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

I. Environment Description

As embodiments of the present invention can implement the J2EE, J2ME, or Enterprise JavaBeans (EJB) application, a brief introduction to J2ME, J2EE, and EJB architectures are provided below. The Java 2, Micro Edition (J2ME) platform is a Java platform for consumer and embedded devices such as mobile phones, Personal Digital Assistants (PDAs), TV set-top boxes, in-vehicle telematics systems, and a broad range of embedded devices. Similar to the enterprise (J2EE), desktop (J2SE™) and smart card (Java Card™) counterparts, the J2ME platform is a set of standard Java application program interfaces (APIs) defined through the Java Community Process^{SM} program by expert groups that include leading device manufacturers, software vendors and service providers.

The J2ME platform delivers the power and benefits of Java technology tailored for consumer and embedded devices. The J2ME provides a flexible user interface, robust security model, broad range of built-in network protocols, and support for networked and disconnected applications. J2ME applications are written for a wide range of devices. As such, the J2ME applications can be downloaded dynamically and leverage each native capability of each device. The J2ME platform can be deployed on millions of devices (e.g., mobile phones, PDAs, automotive devices, etc.) supported by leading Java technology tools vendors and used by companies worldwide. Briefly stated, J2ME is the preferable platform for consumer and embedded devices.

The SDK provides software programmers with the speed, security and functionality to create cross-platform, mission critical applications. The JRE provides the execution environment needed to run Java platform-based applets and applications.

The J2ME architecture defines configurations, profiles and optional packages as elements for building complete Java runtime environments that meet the requirements for a broad range of devices and target markets. Each combination is optimized for the memory, processing power, and I/O capabilities of a related category of devices. The result is a common Java platform that fully leverages each type of device to deliver a rich user experience.

Configurations

Configurations are composed of a virtual machine and a minimal set of class libraries. The configurations provide the base functionality for a particular range of devices that share similar characteristics (e.g., network connectivity, memory footprint, etc.). Currently, there are two J2ME configurations: the Connected Limited Device Configuration (CLDC), and the Connected Device Configuration (CDC):

CLDC

CLDC is the smaller of the two configurations, and by way of example, is designed for devices with intermittent network connections, slow processors, and limited memory (e.g., mobile phones, two-way pagers, PDAs, etc.). By way of example, the devices may have either 16- or 32-bit CPUs, and a minimum of 128 KB to 512 KB of memory available for the Java platform implementation and the associated applications.

CDC

CDC is designed for devices having more memory, faster processors, and greater network bandwidth (e.g., TV set-top boxes, residential gateways, in-vehicle telematics systems, high-end PDAs, etc.). CDC includes a full-featured Java virtual machine, and a much larger subset of the J2SE platform than CLDC. As a result, most CDC-targeted devices have 32-bit CPUs and a minimum of 2 MB of memory available for the Java platform and associated applications.

Profiles

In order to provide a complete runtime environment targeted at specific device categories, configurations can be combined with a set of higher level APIs or profiles that further define the application life cycle model, the user interface, and access to device specific properties.

Mobile Information Device Profile

The Mobile Information Device Profile (MIDP) is designed for mobile phones and entry-level PDAs. Broadly speaking, MIDP can be used on any computing device that needs to take advantage of MIDP's functions. MIDP is a set of Java APIs which, together with CLDC, provides a complete J2ME application runtime environment targeted at mobile information devices, such as mobile phones and entry level PDAs. In this manner, MIDP offers the core application functionality required by mobile applications (e.g., the user interface, network connectivity, local data storage, and application management, etc.). Combined with CLDC, MIDP provides a substantially complete Java runtime environment that leverages the capabilities of handheld devices and minimizes both memory and power consumption.

Currently, CLDC, combined with the MIDP is the Java runtime environment for mobile information devices (MIDs) (e.g., phones, entry level PDAs, etc.). MIDP provides the core application functionality required by mobile applications (e.g., the user interface, network connectivity, local data storage, and application lifecycle management packaged as a standardized Java runtime environment and set of Java APIs, etc.).

Foundation Profile

CDC profiles are layered so that profiles can be added as needed to provide application functionality for different types of devices. The Foundation Profile (FP) is the lowest level profile for CDC and provides a network-capable implementation of CDC that can be used for deeply embedded implementations without a user interface. FP can also be combined with Personal Basis Profile and Personal Profile for devices that require a graphical user interface (GUI).

Personal Profile

The Personal Profile (PP) is the CDC profile aimed at devices requiring full GUI or Internet applet support (e.g., high-end PDAs, communicator-type devices, game consoles, etc.). PP includes the full Java Abstract Window Toolkit (AWT) libraries and offers Web fidelity capable of easily running Web-based applets designed for use in a desktop environment. PP replaces PersonalJava™ technology and provides PersonalJava applications a clear migration path to the J2ME platform.

Personal Basis Profile

The Personal Basis Profile (PBP), is a subset of PP. PBP provides an application environment for network connected devices that support a basic level of graphical presentation or require the use of specialized graphical toolkits for specific applications.Devices (e.g., TV set-top boxes, in-vehicle telematics systems, information kiosks, etc.) Both PP and PBP are layered on top of CDC and FP.

Optional Packages

The J2ME platform can be further extended by combining various optional packages with CLDC, CDC, and their corresponding profiles. In this manner, specific market requirements can be addressed. Furthermore, optional packages can offer standard APIs for using both existing and emerging technologies (e.g., Bluetooth, Web services, wireless messaging, multimedia, database connectivity, etc.). As optional packages are modular, device manufacturers can include the optional packages, as needed, to fully leverage the features of each device.

By way of example, J2ME™ Mobile Media API Reference Implementation Version 1.0 (MMAPI) extends the functionality of the J2ME platform by providing audio, video and other time-based multimedia support to resource-constrained devices. MMAPI allows Java developers to gain access native multimedia services available on a given device.

The reference implementation for MMAPI runs on the CLDC/MIDP profile running on Windows 2000. By way of example, the reference implementation for MMAPI has support for simple tone generation, tone sequencing, audio/video file playback and streaming, interactive MIDI, and audio/video capture. The J2ME MMAPI reference implementation is a source code product provided for porting to various platforms. The MMAPI specification has been developed through the Java Community Process^{SM} (i.e., JSR-135) by an expert group composed of companies representing device manufacturers, wireless operators and software vendors.

As the embodiments of the present invention can also involve using Enterprise Java Beans (EJB)™ in J2EE platform, below are brief descriptions to the J2EE platform and EJBs. The Java™ 2 Enterprise Edition (J2EE™), developed by Sun Microsystems, Inc., is the development and deployment environment for enterprise software applications capable of running on a variety of desktop computers, servers, and other computing devices. J2EE provides architecture for developing, deploying, and executing applications in a distributed-object environment. In one embodiment, the J2EE platform comprises the Java 2 Software Development Kit, Standard Edition (SDK), and Java Runtime Environment (JRE).

J2EE facilitates building Web-based applications. Broadly speaking, J2EE services are performed in the middle tier between the user browser and the databases and legacy information systems. J2EE comprises a specification, reference implementation and a set of testing suites. J2EE further comprises Enterprise JavaBeans (EJB), JavaServer Pages (JSP), Java servlets, and a plurality of interfaces for linking to information resources in the platform.

The J2EE specifications define how applications should be written for the J2EE environment. Thus the specifications provide the contract between the applications and the J2EE platform. However, there exist a class of JAVA applications that require customization of the J2EE platform. These applications generally utilize application specific strategies created by a particular vendor to accomplish specific tasks that are not provided by the general JAVA platform on which the application executes. Examples of this class of JAVA applications include telecommunications applications and services that are deployed within a particular service provider's environment. This class of applications typically requires continuous availability, which means the environment in which the applications operate requires the applications to be available most of the time.

Summarily, EJB architecture promotes the creation of re-usable server-side behaviors or instructions in the Java language, connectors to enable access to existing enterprise systems, and easy-to-deploy program modules. The EJB architecture creates a collaborative architecture to provide services virtually anywhere, and for a wide range of customers and devices, including mobile devices.

The EJB architecture defines a model for the development and deployment of reusable Java server components called EJB components (i.e., EJB beans). As designed, the EJB component is a non-visible server component having methods that provide business logic in a distributed application. In one example, the EJB architecture includes the EJB client and the EJB server. The EJB client is configured to provide the user-interface logic on a client machine and to make calls to remote EJB components on a server. For instance, the EJB client is provided the information as to how to find the EJB server and how to interact with the EJB components.

In one example, the EJB client does not communicate directly with the EJB component. In one aspect, the EJB container provides the client proxy objects that implement the home and remote interfaces of the component. In another instance, the remote interface is configured to define the business methods that can be called by the client. In another embodiment, the client is configured to invoke the methods resulting in the updating of the database. Thus, the EJB beans are reusable components that can be accessed by client programs. The application programmer codes the business logic into the EJBs and deploys them into a J2EE compliant server. In one example, the server complying with the J2EE specification provides the required system-level services, thus allowing the application programmer to concentrate on business logic.

The EJB server (i.e., the EJB application) includes an EJB container, which in one example provides the services required by the EJB component. For instance, the EJB container may be configured to include one of an EJB home interface or EJB Remote interface and EJB beans. In one embodiment, the EJB home interface and the EJB remote interface are defined in the same Java virtual machine. In a different embodiment, the EJB home interface and the EJB remote interface may be defined on different Java virtual machines or separate physical computers.

In one example, the EJB specification defines a container as the environment in which one or more EJB components can be executed. In accordance to one example, the EJB container provides the infrastructure required to run distributed components thus allowing the clients and component developers to focus on programming business logic. Simply stated, the container manages the low-level communications between the clients and the EJB beans. In one example, once an EJB bean is created by a client, the client invokes methods on the EJB bean as if the EJB bean were running in the same virtual machine as the client.

Furthermore, the clients are unaware of activities on the EJB bean, since the container is configured to sit between the clients and the EJB beans. For instance, if an EJB bean is passivated, its remote reference on the client remains intact. Thus, when the client later invokes a method on the remote reference, the container activates the EJB bean to service the request.

The EJB container encapsulates:
The client runtime and generated sub classes. In one example, this allows the client to execute components on a remote server as if the components were local objects.
The naming service allows the clients to instantiate components by name. It further allows components to obtain resources (e.g., database connections, etc.) by name.
The EJB server component dispatcher, which in one example, executes the component's implementation class and provides services such as transaction management, database connection pooling, and instance lifecycle management.

In one example, three types of EJB components can be enumerated.
Stateful session Beans: A stateful session bean manages complex processes or tasks that require the accumulation of data. They further manage tasks that require more than one method call to complete but are relatively short lived, store session state information in class instance data, and have an affinity between each instance and one client from the time the client creates the instance until it is destroyed by the client or by the server.
Stateless session Beans: A stateless session bean manages tasks that do not require the keeping of client session data between method calls. Furthermore, the method invocation by a stateless session bean does not depend on data stored by previous method invocations, there is no affinity between a component instance and a particular client, and different instances of the stateless session beans are seemed identical to the client.
Entity Beans: An entity bean model is a business model that is a real-world object which methods are run on the server machine. When the entity bean method is called, the program's thread stops executing and control is passed to the server. When the method returns from the server, the local thread resumes executing. In one example, the entity beans have the following characteristics: Each instance represents a row in a persistent database relation (e.g., a table, view, etc.); and The bean has a primary key that corresponds to the database relation's key which is represented by a Java data type or class.

Each EJB component further has a transaction attribute configured to determine the manner the instances of the component participate in transactions. As designed, the EJB container provides services which can include transaction and persistence support to the EJB components. As to the transaction support, the EJB container is configured to support transactions. In one example, when the bean is deployed, the EJB container provides the necessary transaction support. In regard to the persistence support, the EJB container is configured to provide support for persistence of the EJB components, which in one embodiment, is defined as the capability of the EJB component to save and retrieve its state. In this manner, the EJB component does not have to be re-created with each use.

In one example, the EJB architecture is a three-tiered architecture in which the clients reside on the first tier, the application server and the components (i.e., EJB beans) reside on the second tier, and the databases reside on the same host as the EJB server. In accordance to one implementation, the EJB server executes methods on a component from the client or another component, retrieves data from databases, and performs other communications. The EJB server further handles the details of transactions, threads, security, database connections, and network communication. Summarily, the EJB clients request business-logic services from EJB beans running on the second-tier. The EJB beans then use the system services provided by the second-tier server to access data from existing systems in the third tier. The EJB beans apply the business rules to the data, and return the results to the clients in the first-tier.

In one example, the client contains the user interface. The business logic is configured to be separate from both the clients and the databases and resides in the same tier (i.e., second tier) as components that analyze data, perform computations, or retrieve information from data sources and processes.

As J2ME, J2EE, and EJBs use the Java™ (hereinafter “Java”) programming language, in a like manner, an overview of Java is provided below. In operation, a user of a typical Java based system interacts with an application layer of a system generally written by a third party developer. The application layer generally provides the user interface for the system. A Java module is used to process commands received by the application layer. A Java virtual machine is used as an interpreter to provide portability to Java applications. In general, developers design Java applications as hardware independent software modules, which are executed Java virtual machines. The Java virtual machine layer is developed to operate in conjunction with the native operating system of a particular hardware, which represents the physical hardware on which the system operates or runs. In this manner, Java applications can be ported from one hardware device to another without requiring updating of the application code.

Unlike most programming languages, in which a program is compiled into machine-dependent, executable program code, Java classes are compiled into machine independent byte code class files which are executed by a machine-dependent virtual machine. The virtual machine provides a level of abstraction between the machine independence of the byte code classes and the machine-dependent instruction set of the underlying computer hardware. A class loader is responsible for loading the byte code class files as needed, and an interpreter or just-in-time compiler provides for the transformation of byte codes into machine code.

More specifically, Java is a programming language designed to generate applications that can run on all hardware platforms, small, medium and large, without modification. Developed by Sun, Java has been promoted and geared heavily for the Web, both for public Web sites and Intranets. Generally, Java programs can be called from within HTML documents or launched standalone. When a Java program runs from a Web page, it is called a “Java applet,” and when run on a Web server, the application is called a “serviet.”

Java is an interpreted language. The source code of a Java program is compiled into an intermediate language called “byte code”. The byte code is then converted (interpreted) into machine code at runtime. Upon finding a Java applet, the Web browser invokes a Java interpreter (Java Virtual Machine), which translates the byte code into machine code and runs it. Thus, Java programs are not dependent on any specific hardware and will run in any computer with the Java Virtual Machine software. On the server side, Java programs can also be compiled into machine language for faster performance. However a compiled Java program loses hardware independence as a result.

II. Optimized Start-up of Downloaded Mobile Device Applications

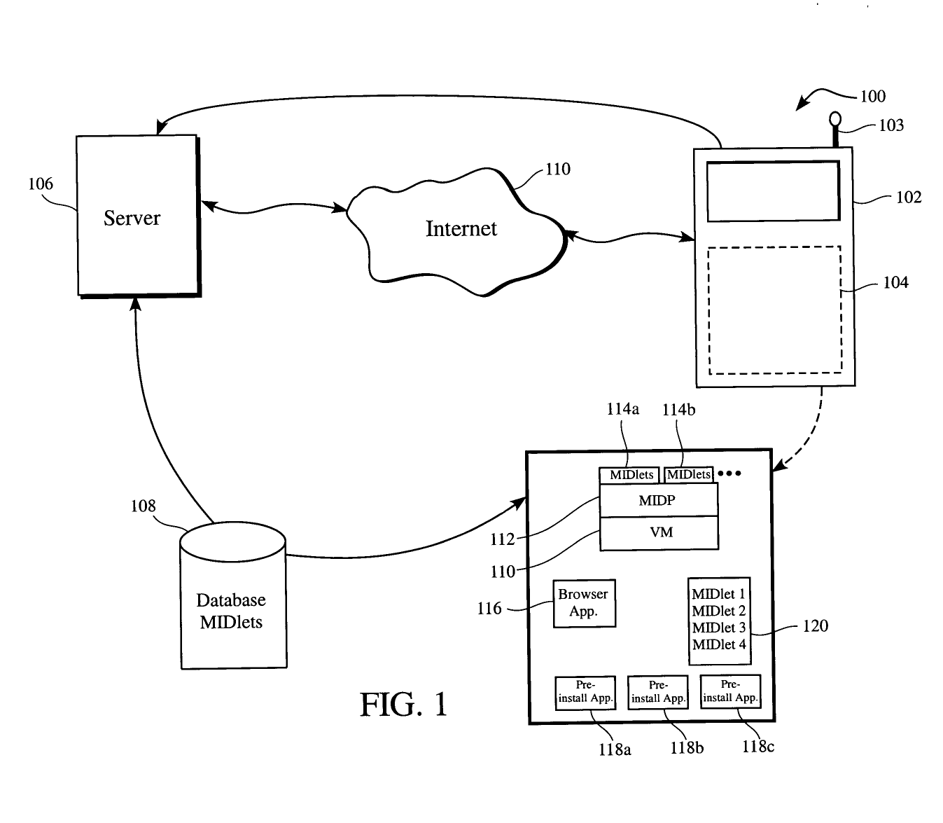

Keeping the overviews to J2EE, J2ME, EJBs, and Java in mind, reference is made to FIG. 1 showing a simplified block diagram of an exemplary system 100 depicting the selection a downloadable application by an embedded mobile device 102, in accordance with one embodiment of the present invention. The system 100 includes a server 106 in communication with the embedded mobile device 102 via Internet 110. server 106 is shown to store data in an application repository 108, which in this embodiment is a database. In the example shown in FIG. 1, the server 106 is a server specifically designed to serve J2ME applications, and includes a plurality of MIDlets stored to the application repository 108.

The illustrated embedded mobile device 102 includes a storage 104. As shown, the storage 104 includes a MIDP 112 that runs on top of a virtual machine (VM) 110. The storage 104 further includes a plurality of downloadable MIDlets 114a and 114b that have already been downloaded from the application repository 108 to the storage 104 of the mobile device 102. The storage 104 is shown to further include a browser application 116 and a plurality of pre-installed applications 118a-118d.

As can be seen, the MIDlets 114a and 114b run on top of the MIDP 112 and VM 110. In one embodiment, the VM 110 interoperates using byte code format, a middle level machine instruction that can be translated into native CPU instructions. The VM 110 is configured to execute the byte codes and convert the byte codes into platform dependent machine code.

In one embodiment, the device 102 can browse through the server 106 and the application repository 108 of MIDlets via Internet 110. Initially, the device 102 uses the browser application 116 to dispatch a browse request to the server 106 so as to request a list of all the MIDlets stored to the application repository 108 available to the device 102. At this point, a list 120 of all the MIDlets available to the device 102 stored in the application repository 108 is provided to the device 102. As can be seen, the MIDlet list 120 includes all the MIDlets available to be downloaded to the device 102, which in this example are MIDlet 1, MIDlet 2, MIDlet 3, and MIDlet 4.

In one example, the browser application 116 can be a fixed application configured to discover applications in the server application repository 108. In another instance, the device 102 displays the list 120 using a graphical user interface. In yet another example, the device 102 may receive the list 120 using Wireless Markup Language (WML), HyperText Markup Language (HTML) language, etc. Of course, it must be noted that any suitable communication process will work, so long as the connection and communication is established.

In accordance with the embodiments of the present invention, once downloaded, MIDlets 1-4 can be executed as if MIDlets 1-4 are pre-installed MIDlets (e.g., MIDlets 114a, 114b, etc.). The process for enabling the downloaded MIDlets to behave similar to faster start-up pre-installed applications will be described in detail below. MIDlets 1 through 4, herein referred to as “downloadable applications” or “downloadable MIDlets” are configured to be executed on the device 102 as if MIDlets 1 through 4 are pre-installed applications. By way of example, the user of the device 102 can select to download and install the downloadable MIDlet 1 from the list 120. Additional information with respect to downloading and execution of downloadable MIDlets are provided below.

The embodiment of FIG. 1 shows the server 106 in communication with the mobile device 102 via the Internet 110. Generally speaking, the server 106 and the embedded mobile device 102 can communicate using any appropriate communication format (e.g., HyperText Transfer Protocol (HTTP), Linear Network Analysis Package (LNAP), Linear Wireless Application Protocol (LWAP), etc.). Furthermore, the communication link between the Internet 110 and the device 102 or the server 106 can be any appropriate communication link (e.g., Open and modular development environment (EDMA) network, global systems for Mobile Communications (GSM) network, cable connection, etc.). Additionally, as mentioned above, the device 102 and the server 106 can be configured to implement Java programming language.

In accordance with one embodiment of the process, the device 102 needs to be connected to server 106 via the Internet 110 while the downloadable application is being downloaded from the server 106 to the device 102. Thus, the user pays for the air fee associated with the download time (i.e., period of time during which the application is being downloaded from the application repository 108 to the device 102). Furthermore, in the present invention, the downloadable MIDlets or applications can be downloaded to any appropriate device data storage (e.g., memory, random access memory (RAM), flash memory, hot disc, mini hot disc, etc.).

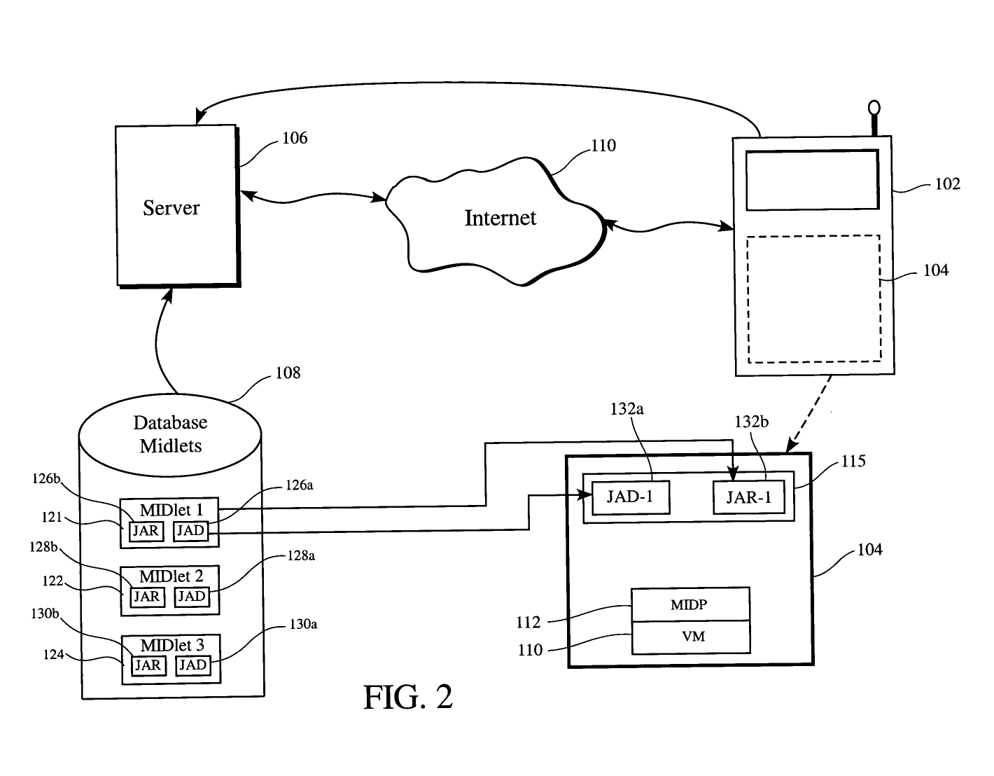

Referring to FIG. 2, a simplified block diagram of the system 100 during installation of MIDlet 1 is shown, in accordance with one embodiment of the present invention. As can be seen, each of the plurality of MIDlets 121-124 is packaged into two separate files, a JAD file and a JAR file. For instance, MIDlet 1 121 is packaged into a JAD file 126a and a JAR file 126b, MIDlet 2 122 is packaged into a JAD file 128a and a JAR file 128b, and MIDlet 3 is packaged into a JAD file 130a and a JAR file 130b.

The JAD file 126a, as used herein, is defined to include the text description of the application or the MIDlet suite 121. In one example, the JAR file 126b, however, the JAR file 126b is configured to contain the class files of the application or MIDlet as well as all extra auxiliary resources associated with the application or MIDlet (e.g., resource files needed by the application or MIDlet, graphics, audio data, et.). In one embodiment, the JAR files are a file format that is used to package most of the components required by MIDP and VM. Because most of the components of the MIDlets (e.g., class files, images, sounds, etc.) can be packaged into a single file, JAR files are configured to simplify the downloading of applets. Additionally, JAR files support data compression designed to decrease download time and security signing.

During the installation stage, copies of a JAD file 132a and a JAR file 132b of the MIDlet 1 121 are shown to be stored to the storage 104 of the device 102. In one example, after the device 102 issues the browse request and starts browsing the application repository 108, the server 106 sends a response to the device 102 with a list 120 of all the applications or MIDlets available to the device 102. Then, the device 102 dispatches a request to the server 106, requesting installation of the downloadable MIDlet or application 121. At this point, the server 106 sends the JAD file 126a of the MIDlet 121 to the device 102. The device 102 inspects the JAD file 132a so as to configure and calculate the storage size needed for installing the MIDlet 121, whether such storage size is available, whether the JAD file 132a is permitted to be copied, whether the device 102 has been granted security clearance to access the MIDlet 121, etc.

Assuming that all the requirements of the JAD file 132a can be accommodated by the device 102, the device 102 dispatches a request to the server 106, requesting the context of the downloadable MIDlet 121, which in this embodiment, is stored to the JAR file 126b. In one example, the JAR file 126b is a generic and cross-platform file and thus is not specific to the device 102. As can be appreciated, the JAR file 126b has been downloaded to the storage 104 of the device 102 as the JAR file JAR-1 132b.

One of ordinary skill in the art must appreciate that although in the embodiment of FIG. 2, the JAR files 126b, 128b, and 130b are generic cross-platform files, in a different embodiment, a request for obtaining a customized JAR file can also be achieved. A customized JAR file stored to the application repository 108 may have been cosmetically modified and designed to implement a specific color, different icons, etc.

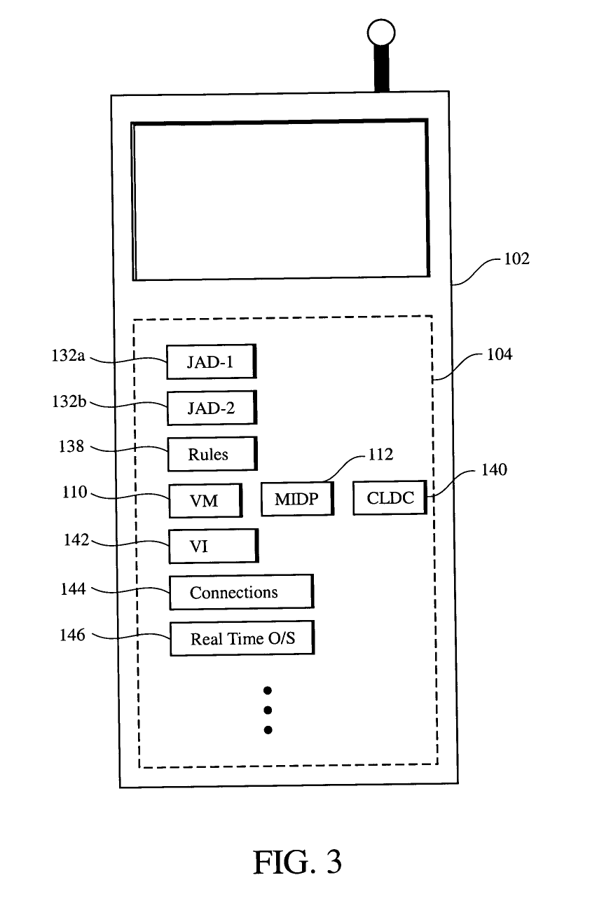

Continuing to FIG. 3, a simplified block diagram illustrating the contents of an exemplary storage 104 of an exemplary embedded mobile device 102 subsequent to the downloading of the downloadable MIDlet 121 is shown, in accordance with one embodiment of the present invention. As illustrated, the exemplary storage 104 includes the JAD-1 132a file and the JAR-1 132b file of the downloadable MIDlet 121. Further included are the rules 138 which are specifically written per device 102. For instance, an exemplary device 102 may have a rule allowing the installation of JAD files having less than, for instance, 30 Kbytes. Another example is a rule according to which a device may require JAR files created by Sun Microsystems, Inc. having “sun.com” be installed on the device. Yet another example is that the device may be configured not to support colors, etc.

Also included in the storage 104 of the embodiment shown in FIG. 3, are the virtual machine 110, the MIDP 112, and CLDC 140. As discussed in more detailed previously, MIDP 112 is a set of Java APIs configured to run on top of the virtual machine 110. CLDC 140 together with the MIDP 112 are configured to provide the J2ME application runtime environment targeted at the embedded mobile device 102. Of course, it must be noted that any product created and developed by any company capable of providing device-server communication interface can be implemented.

As illustrated, the storage 104 also includes the user interface 142 and real time operating system 146. Also shown are the network connections 144. The device storage 104 maybe defined inside a flash ROM, a hard drive, or some type of storage.

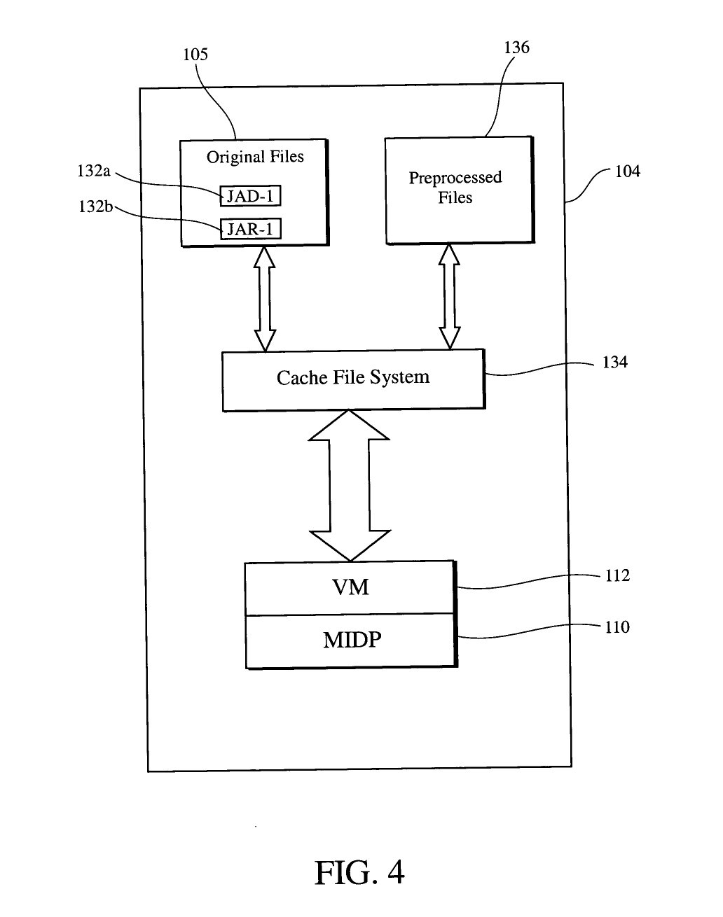

Proceeding to FIG. 4, the storage 104 of the exemplary device 102 is shown during a pre-process stage, which is done directly on the device 102, in accordance with one embodiment of the present invention. Pre-processing on the device 102 enables processing of the downloaded application into a format that is specific to the device 102. Accordingly, the device 102 need not engage in a time consuming protocol exchange with a server to identify itself and then obtain device-specific code. As can be seen, in the pre-processed stage, the storage 104 includes the MIDP 112 defined on top of VM 110, a cache file system 134 (defined on top of the MIDP 112), original files 105, and pre-processed files 136. The original files 105 includes the JAD file JAD-1 132a and the compressed JAR file JAR-1 132b of the downloadable MIDlet 121. As used herein, the cache file system 134 includes computer program instructions designed to access the JAD file JAD-1 132a and the JAR file JAR-1 132b in the original files 105, so as to pre-process and convert the original files 105 into the respective pre-processed files 136. In one instance, the cache file system 134 is configured to include a mapping of substantially all the changes made to the original JAR file while the JAR file is being pre-processed and the pre-processed file is being generated. In one example, when a request is dispatched by the VM 110 for a specific original file, the cache file system 134 is capable of translating the request that is typically directed to the original JAR file to the corresponding pre-processed files 136.

It must be noted that in the embodiment shown in FIG. 4, neither the VM 110 nor the MIDP 112 has been modified. Rather, by using the cache file system 134 (i.e., the sharable computer code), a request from the underlying layer (e.g., the VM 110 and the MIDP 112) is translated, substantially eliminating the need to modify the MIDP 112 or the VM 110. As can be appreciated, in one example, the pre-processing is performed so as to decompress the compressed original files 105. Once decompression is complete, the MIDlet is stored in the device 102 similarly to pre-installed applications. Accordingly, when a user desires to launch the MIDlet anytime after pre-processing, the user will not have to decompress the application again. This will significantly increase start-up time of the downloaded MIDlet.

One of ordinary skill in the art must appreciate that once the original files 105 have been processed using the cache file system 134, the original files 105, including the original JAR and JAD files 132a and 132b will not be functionally used. However, the original JAR and JAD files 132a and 132b that define the MIDlet application will still be referenced by the VM when a user desires access to the application. As discussed below, the request for the original MIDlet will mapped to the contents of the pre-processed files 136. Consequently, the device 102 will not have to process the files again and will simply use the pre-processed version.

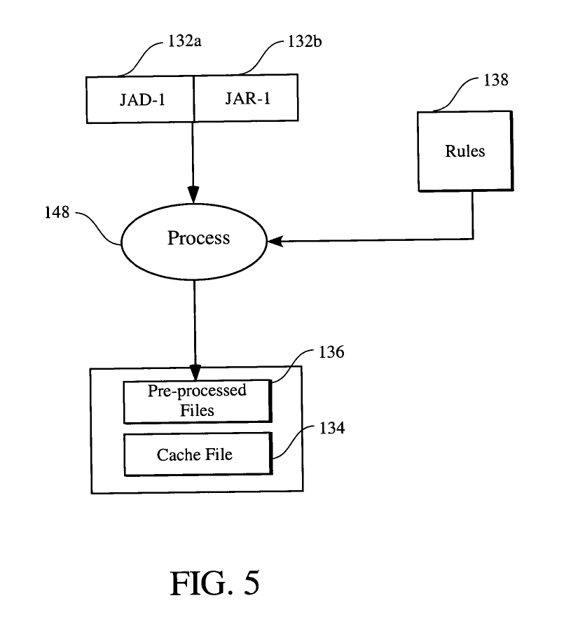

Continuing to FIG. 5, a block diagram illustrating exemplary actions performed during an installation phase of an exemplary downloadable application on the device 102 is shown, in accordance with one embodiment of the present invention. As can be seen, the JAD file JAD-1 132a and the JAR file JAR-1 132b are processed in a process 148 using the rules 138 defined in the storage of the device, generating the pre-processed files 136 and the cache file system 134. As can be appreciated, in one embodiment, the cache file system 134 can be created along side the pre-processed files 136.

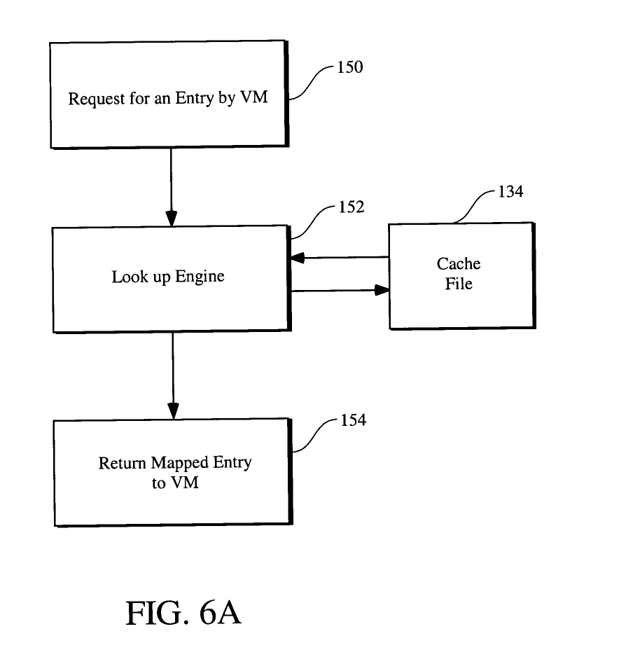

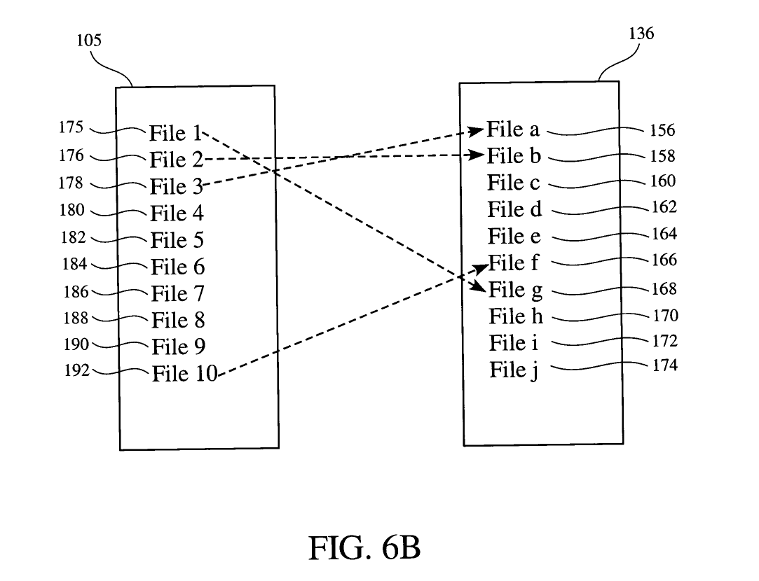

Shifting to FIG. 6A, a block diagram illustrating exemplary actions performed during a run time phase of a downloadable application on the device 102, in accordance with one embodiment of the present invention. By way of example, a request for an entry is received from the VM 150, which in one embodiment can be a file. At this point, the cache file system 134 and the request for the entry by VM 150 are used as inputs to a look-up engine 152. Using the mapping in the cache file system 134, the look up engine 152 finds the correct return entry that corresponds to the entry requested. Thereafter, the look-up engine 152 sends the mapped entry to the VM in 154. In one instance, the look up engine 152 is configured to be computer instructions that receive an input from the cache file and returns the corresponding pre-processed entry during the run phase.

Mapping of entries between the original files 105 and the pre-processed files 136 can be understood further with respect to the simplified diagram shown in FIG. 6B, in accordance with one embodiment of the present invention. As illustrated, the original files 105 includes a plurality of entries, which in the embodiment of FIG. 6B, are files 1 175 through files 10 192. After pre-processing the entries 175 through files 192, the pre-processed files 136 are generated. In the implementation shown in FIG. 6B, the pre-processed files 136 includes files a 156 through file J 174. As can be appreciated, the original file 1 175 has been translated to file g 168, file 2 176 has been pre-processed to file B 158, file 3 178 has been translated to file a 156, and file 10 192 has been translated to file f 166.

In this manner, when the VM dispatches a request for a file, for instance, the file 10 192, the look-up engine can return the mapped entry, file f 166. This is achieved by the look up engine using the input file 10 192 and the contents of the cache file (e.g., the mapping data), thus returning the corresponding mapped and pre-processed entry. In this manner, locating the pre-processed file is substantially easier. It must be appreciated that, in contrast to the original files wherein the JAR file is in the compressed image form, the mapped file (e.g., the pre-processed file) is pre-processed. Specifically, the original file has been decompressed and translated to the local native format of the particular device. In this manner, the need to download the MIDlet to the device every time the consumer wishes to execute the MIDlet is eliminated. Rather, in accordance with the embodiment of the present invention, the downloadable applications are downloaded, decompressed, and translated to the native format of the device, once. As a result, the downloaded MIDlets can behave similar to fast start-up pre-installed applications existing on the device. One must appreciate that, depending on the embodiment, the pre-processing may defer. For example, in one embodiment, the pre-processing is configured to involve decompressing the original file and converting same into the native format of the particular device. However, in another embodiment, any appropriate pre-processing can be implemented so long as the start-up time of applications is optimized.

In one example, the cache file is created along with the pre-processed files. For instance, the original java file is pre-processed according to the rules of the specific device and is defined in the format desired for the specific device, which for instance, may be the native format. In this manner, every time an original file is pre-processed, the cache file can be updated, allowing the cache file to be created and processed almost at the same time as the pre-processed file. Thus, each time an original file is pre-processed, the cache file is updated approximately at the same time, ensuring that the cache file and the pre-processed files are substantially current.

For instance, in one example, the rule may be uncompressing all PNG files and converting same to the device hardware dependent format, as follows:
jar(5.A. png)−→C-A.BMP (native format).

In this manner, the entries for each of the downloadable files is decompressed and converted into the device native format. That is, as the original files are being pre-processed in accordance with the rules for the specific device, the cache file stores the mapped data representing the entry previously pre-processed as opposed to the data that is being requested. In one example, each MIDlet suite or application is configured to have a corresponding cache file system.

Table 1 below shows an exemplary simple C-like pseudo-code for the installation phase of a downloaded application.

TABLE 1
Pseudo Code for Installation Phase

// During the installation phase, the device is configured to pre-process the application
// based on the information received from external resources. The information may
// include application description file, device capability, special device limitation, etc.
// The external resources may be a text file. The pre-processed application is
// configured to have a better performance and stan-up time. As a result, the pre-
// processed application can run as if the application is a pre-installed application.
Install_Download_Application( ) {
// Obtain a description of the limitation of the device. The
// rules may be set by the device manufacturer or may dynamically
// change according to the condition of the current device or the
// networking service connection.
// In the MIDP environment, obtaining the limitation of the device may also include
// reading a JAD file from the server.
// rules.getApplicationDescription( ) will return the JAD file
// content.
Rules rules = Obtain_Device_Rules_Limitation( );
// Download the main content of the application. The main content is
// preferably in a compressed format.
Entries main_entry = Download_Application_Main_Content( );
// For each entry in the application main context, loop
// through each entry in the application main context and apply the condition from the
//Rules file.
while (context_entry = main_entry->Read_A_Entry( )) {

Action action = rules.Get_Action_Associated(context_entry);
if (action) { // When there is a action available

```
Switch (action) {
  case ACTION_NOTHING: continue;
  case ACTION_UNCOMPRESS: Uncompress(context_entry);
  break;
  case ACTION_UNCOMPRESS_CONVERT_RESOURCE:
  Uncompress(context_entry); Convert(context_entry);
  break;
  case ACTION_CONVERT_BYTECODE:
  ConvertCodetoNative(context_entry); break;
  case ACTION_UNKNOWN: continue; break;
  // etc.
}
// Update a cache file so that during runtime, the system can
// read the processed context from the local main
// system memory instead of from the compressed content.
Update_Cache(context_entry);
```

}

}
}

One of ordinary skill in the art should appreciate that in one embodiment, the limitation of the device, as used in the pseudo code, are the device rules. Furthermore, in one example, the device rules are set by the manufacturer. Additionally, one must note that the JAR file and the JAD file may not need to be downloaded if the JAR file and the JAD file have already been downloaded to the device.

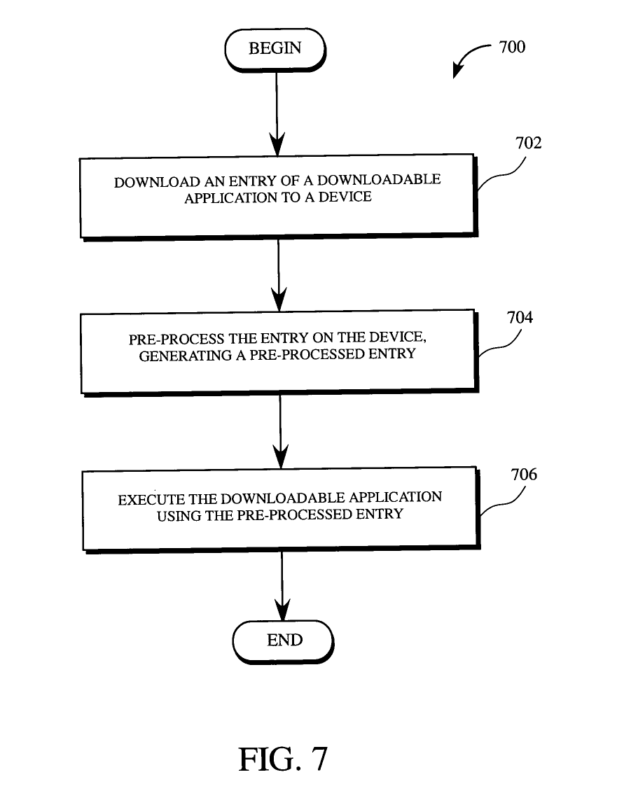

Reference is made to FIG. 7 depicting flowchart 700 of method operations performed during downloading of a downloadable application, in accordance with one embodiment of the present invention. The method begins in operation 702 in which an entry of a downloadable application is downloaded to a device. As described in more detail above, an entry can be a file, an image, a resource file required by the application or MIDlet, etc. Furthermore, a device can be an embedded mobile device, a PDA, a mobile phone, etc.

The method next continues to operation 704 in which the entry is pre-processed on the device, generating a preprocessed entry. By way of example, where the downloadable application is a J2ME MIDlet, the entries are JAD files and JAR files. Proceeding to operation 706, the downloadable application is executed on the device using the pre-processed entry.

In this manner, the execution of downloadable-applications is highly optimized because it is not necessary to have knowledge of the device rules and formats prior to the downloading operation. Furthermore, in addition to the raw execution speed, the start-up time of the downloadable applications is substantially lowered thus allowing the end users to utilize downloadable applications with almost instantaneous action and feedback.

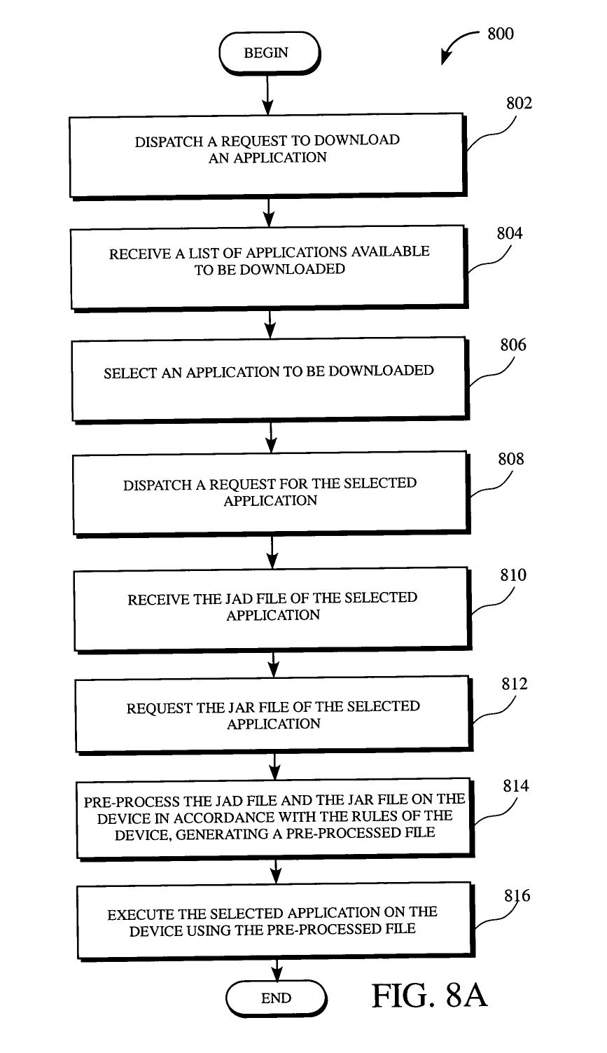

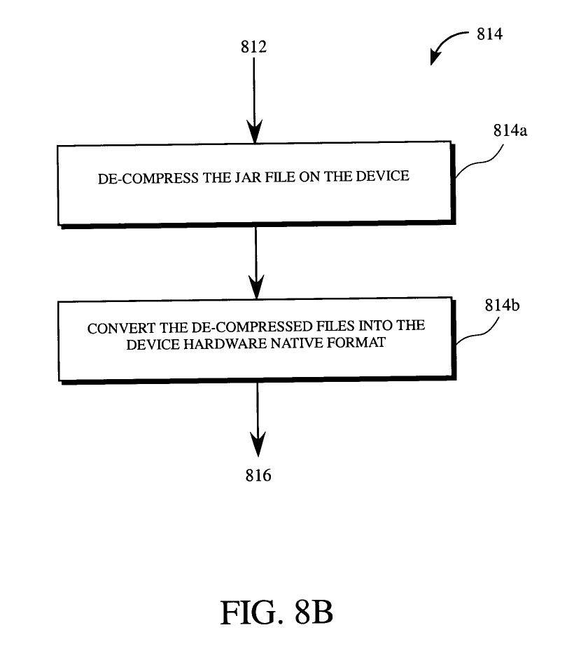

FIG. 8A shows a flowchart 800 of method operations performed during downloading and installation of a downloadable application from a server, in accordance with one embodiment of the present invention. The method begins with operation 802in which a request to download an application is dispatched by a device. In one embodiment, the device is a mobile device running J2ME while the application being downloaded over the media is a MIDlet suite running J2ME. As described in more detail above, each MIDlet is packaged into two different files, a JAD file and a JAR file with the JAD file being a text-based description of the JAR file. It must be noted that although that in one embodiment of the present invention the start-up time of a downloadable-application in a mobile device is enhanced by using J2ME, in another example, the embodiments of the present invention may implement any appropriate environment so as to increase the start-up time of downloadable applications on the device.

Next, in operation 804, the server dispatches a list of applications available to be downloaded by the mobile device. The method thereafter continues to operation 806 in which the device selects an application to be downloaded followed by operation 808 in which the device dispatches a request for the selected application. Proceeding to operation 810, the JAD file of the selected application is dispatched to the device. Using the text in the JAD file, the device determines whether the device can accommodate the size and requirements of the selected applications as defined in the JAD file. Proceeding to operation 812, the device dispatches a request to the server requesting the JAR file of the selected application. As discussed in greater detail above, the JAR file includes the context of the application.

Next, in operation 814, the JAD file and the JAR file are pre-processed on the device in accordance with the rules of the device so as to generate a pre-processed file. In operation 816, the selected application is executed on the device using the pre-processed file.

FIG. 8B depicts method operations performed in pre-processing the JAR and JAD files, as depicted in operation 814. In operation 814a, the JAR file is decompressed on the device. Thereafter, in operation 814b, the decompressed files are converted into the device hardware native format. Next, the method continues to operation 816.

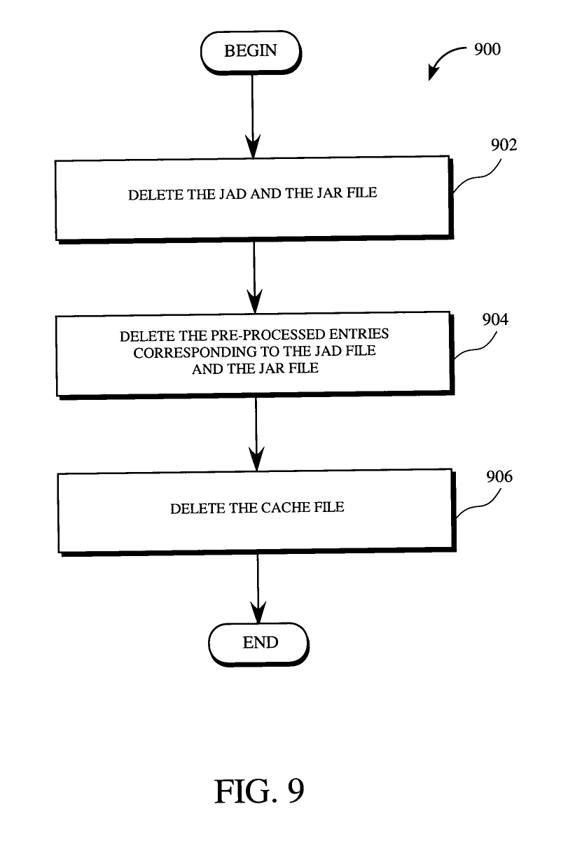

Proceeding to FIG. 9, a flowchart 900 of method operations performed to uninstall a downloadable application installed on a device is provided, in accordance with one embodiment of the present invention. The method starts with operation 902 which the JAD file and the JAR file are deleted followed by deleting the pre-processed entries corresponding to the JAD file and the JAR file using the mapping defined in the cache file in operation 904. Next, the method continues to operation 906 in which the cache file is deleted.

The advantages of the present invention are numerous. Most importantly, the start-up time associated with the downloadable applications improves substantially. In this manner, the responsiveness of the downloadable applications is comparable to that of pre-installed applications. Another advantage of the presents invention is that the device rules can be updated dynamically during the pre-processing, thus limiting the mapping performed between the original entries and the pre-processed entries. Yet another advantage of the present invention is that a limited amount of data in the entries can be selected to be pre-processed or decompressed. This is specifically beneficial when decompressing of the files may occupy too much space.

Still another advantage is that merely a portion of the application can be converted to the device hardware native format. For instance, the application may be processed partially and be interrupted, concluding the processing. In this manner, the original entries, such as the original JAR and JAD files, still exist and can be processed later on, if necessary. In such a scenario, the cache file is marked to reveal that a certain entry or a certain portion of an entry has not been changed, enabling reverting back to the original JAR file. Yet another advantage of the present invention is that memory consumption is reduced as the need to uncompress the data of the downloadable application while the downloadable application is being run on the device no longer exists. Still other advantages of the present invention is saving the future resources, CPU time, and processing power. Lastly, the installation time of the downloadable application can be slightly longer due to the pre-processing of the application. However, such delay is due to a one-time process as the downloadable application is pre-processed once on the device and not every time the downloadable application is launched.

Although specific reference is made to terminology defined by Sun Microsystems, Inc., it should be understood that any name can be used for such terms, so long as the desired functionality is achieved. For instance, reference is made to JAR and JAD files, but in a broad sense, these terms simply define computer code and data. The same applies to the underlying environment for the device 102. Device 102 can be any mobile device, and the device can run any operating system. The operating system can support any communication protocol, including protocols for downloading application files. The application files, once downloaded are pre-processed as defined above, and then stored on the device 102. In subsequent use of the downloaded and pre-processed application, the device 102 will simply access the pre-processed version of the application. Accordingly, any reference to a particular standard should be viewed only as exemplary and focus should be placed on the claimed functional operation.

With the above embodiments in mind, it should be understood that, the invention may be practiced with other computer system configurations including hand-held devices, microprocessor systems, microprocessor-based or programmable consumer electronics, minicomputers, mainframe computers and the like. Furthermore, the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion. Furthermore, although the present invention implements Java programming language, other programming languages may be used to implement the embodiments of the present invention (e.g., C, C₊₊, any object oriented programming language, etc.).

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for installing an application on a mobile device, comprising:
obtaining the application over a network;
storing the application on the mobile device;
processing the application on the mobile device, the processing configured to generate a processed application;
storing the processed application on the mobile device;
requesting access to the application;
mapping the request to access the application to the processed application; and
launching the processed application on the mobile device.

2. A method as recited in claim 1, wherein the operation of processing the application on the mobile device includes,
decompressing the application on the device generating a decompressed application; and
converting the decompressed application into a native format of the device generating a processed application.

3. A method as recited in claim 2, further comprising:
generating a cache file system, the cache file system configured to include a mapping of the application to the processed application.

4. A method as recited in claim 3, wherein the cache file system is generated as the decompressed application is converted into the native format of the device.

5. A method for accessing an application on a mobile device, comprising:
obtaining the application over a network;
storing the application on the mobile device;
processing the application on the mobile device, the processing configured to generate a processed application;
storing the processed application on the mobile device; and
requesting access to the application after installing the application on the mobile device, the request being mapped to the processed application, and the processed application being launched.

6. A method as recited in claim 5, wherein the operation of processing the application on the mobile device includes,
decompressing the application on the device generating a decompressed application; and
converting the decompressed application into a native format of the device generating a processed application.

7. A method as recited in claim 6, further comprising:
generating a cache file system, the cache file system configured to include a mapping of the application to the processed application.

8. A method for improving start-up time of a downloadable application on a device, the method comprising:
downloading an entry of the downloadable application to the device;
pre-processing the entry on the device;
generating a pre-processed entry; and
executing the downloadable application on the device using the pre-processed entry.

9. A method as recited in claim 8, wherein the operation of pre-processing the entry on the device includes,
decompressing the entry on the device generating a decompressed entry; and
converting the decompressed entry into a native format of the device generating a mapped entry.

10. A method as recited in claim 9, further comprising:
generating a cache file system, the cache file system configured to include a mapping of the entry to the mapped entry.

11. A method as recited in claim 10, wherein the cache file system is generated as the decompressed entry is converted into the native format of the device.

12. A method as recited in claim 8, wherein the downloadable application is a MIDlet.

13. A method as recited in claim 8, wherein the device is an embedded mobile device.

14. A method as recited in claim 8, wherein the downloadable application is stored to an application repository of a server.

15. A method as recited in claim 14, wherein the server is executed on a platform for consumers and embedded mobile devices.

16. A method for improving start-up time of a downloadable application on a device, the method comprising:
downloading an entry of the downloadable application to the device;
decompressing the entry on the device generating a decompressed entry;
converting the decompressed entry into a native format of the device generating a pre-processed entry;
generating a cache file system, the cache file system configured to include a mapping of the entry to the pre-processed entry; and
executing the downloadable application on the device using the pre-processed entry.

17. A method as recited in claim 16, wherein the cache file system is generated as the decompressed entry is converted into the native format of the device.

18. A method as recited in claim 16, wherein the device is an embedded mobile device.

19. A method for uninstalling a downloadable application installed on a device, the method comprising:
deleting an entry of the downloadable application previously installed on the device;
deleting the pre-processed entry corresponding to the entry; and
deleting a cache file system.

20. A method as recited in claim 19, wherein the entry includes a JAD file and a JAR file.

21. A method as recited in claim 19, wherein the cache file system contains a mapping of the entry to the pre-processed entry.
